(19) United States
(12) Patent Application Publication
(10) Pub. No.: US 2018/0334188 A1
(43) Pub. Date: Nov. 22, 2018

(54) METHOD FOR THE PLANNING OF TRAJECTORIES

(71) Applicant: GM GLOBAL TECHNOLOGY OPERATIONS LLC, Detroit, MI (US)

(72) Inventor: Oliver Maier, Worms (DE)

(73) Assignee: GM GLOBAL TECHNOLOGY OPERATIONS LLC, Detroit, MI (US)

(21) Appl. No.: 15/981,379

(22) Filed: May 16, 2018

(30) Foreign Application Priority Data
May 16, 2017 (DE) 102017004651.4

(51) Int. Cl. B62D 15/02; G06K 9/00; G06T 7/13

(52) U.S. Cl. CPC B62D 15/0265; B62D 15/029; G06K 9/00798; G06T 7/13; G06T 2207/30256; B60Y 2400/3015; B60Y 2300/28; G06T 2207/30241; B60Y 2300/1815

(57) ABSTRACT

A method and system is disclosed to operate a vehicle pulling a trailer through a cornering maneuver is disclosed. An outer, concave edge and an inner, convex edge of a negotiable road are identified. A path of travel is determined for an inner wheel of the trailer of the vehicle. A first directrix is determined on which a guide point of the vehicle must move in order to pull the inner wheel along the determined path of travel. A second directrix is determined, on which a outer, front wheel of the vehicle must move in order to pull the guide point along the first directrix. A concave-side distance between the outer, front wheel and the concave edge is estimated. When the difference between the distance on concave-side and convex-side exceeds a threshold value, the convex-side distance is adjusted to be closer to the concave-side distance.

### CROSS-REFERENCE TO RELATED APPLICATION

This application claims priority to German Patent Application No. 102017004651.4, filed May 16, 2017, which is incorporated herein by reference in its entirety.

### TECHNICAL FIELD

The present disclosure pertains to a method and system for operating a vehicle pulling a trailer through a cornering maneuver along a trajectory.

### BACKGROUND

When a two-axle vehicle that is steered on the front axle executes a turn, the rear axle always moves on a tighter radius than the front axle. If a driver does not take this into account in the steering of the vehicle, the side of the vehicle may collide with an obstacle at the edge of the roadway, a curb may be run over, or similar mishap.

To address this situation, a vehicle may be counter-steered before entering a tight curve in the other direction so as to increase the distance from the edge of the roadway, and to increase the radius on which the curve is traversed. If the vehicle is pulling a trailer, the wheels of the trailer undergo a turn on a track, the radius of which is even tighter than that of the track on which the rear axle of the vehicle is moving. In this circumstance, the level of a required counter-steer may be difficult to plan, especially when maneuvering in a flow of traffic.

From EP 3031687 A2 a driver assistance system is disclosed, which is intended to be suitable for guiding a vehicle with a trailer on a curved roadway. For this purpose, the deviations of a point on the vehicle and a point on the trailer from the center of the roadway are detected, and in the event of a deviation, a command may be issued to the vehicle steering system, which maintains both points on the center of the roadway. What this command might look like, and in particular how the vehicle could be steered, if differing deviations of the two points from the center of the roadway require differing, or possibly even opposing steering maneuvers, is not described.

### SUMMARY

In accordance with the present disclosure, an executable method is provided to forecast or plan a trajectory of a vehicle with a trailer, in which a concave and a convex edge of a negotiable road surface is identified. A path of travel is determined for a wheel of a trailer of the vehicle facing towards the convex edge at a convex-side distance from the convex edge. A first directrix is computed on which a guide point of the vehicle must move in order to pull the trailer wheel along the determined path of travel. A second directrix is computer on which a front wheel of the vehicle facing towards the concave edge must move in order to pull the guide point along the first directrix. A concave-side distance between the front wheel and the concave edge is estimated. When the difference between the concave-side distance and convex-side distance exceeds a threshold value, the convex-side distance is adjusted so as to be closer to the concave-side distance. This method may return to determining the path of travel and repeat.

In executing this method, a path of travel, on which the wheel facing towards the convex edge of the trailer (hereinafter also referred to as the inner wheel) can maintain a safe distance from the convex edge, and is an acceptable path of travel and starting point for the initiating a trajectory of the vehicle. This inner wheel, an opposing outer wheel and a trailer coupling form what is in general an isosceles triangle. The paths of the trailer coupling and the inner wheel stand in a directrix-tractrix relationship, which, starting from the path of travel of the inner wheel, allows the construction of the path of the trailer coupling as a first directrix. Since the trailer coupling also has a fixed position relative to the vehicle, this first directrix at the same time defines the path of a point of the vehicle, which, in turn, stands in a directrix-tractrix relationship with the paths of its steerable front wheels. Of the paths of the front wheels, here only that of the outer front wheel facing towards the concave edge of the roadway is of interest, since that of the inner front wheel runs between the paths of the outer front wheel and the inner wheel of the trailer.

In order to ensure that there is a path that can be negotiated by the vehicle and the trailer, it is therefore sufficient to verify that the path of the outer front wheel runs on the negotiable road surface. In order to ensure that a path is found that is not only in some way negotiable, but is negotiable in the best possible manner, the concave-side distance between the outer front wheel and the concave edge is estimated. If the latter and the convex-side distance differ too greatly, then the trajectory of the vehicle evidently runs at some distance from the center of the negotiable road surface, and it would be better to drive along a path running closer to the center in case of doubt. In order to find such a path running close to the center, the convex-side distance can be adjusted so as to be closer to the concave-side distance, and the method can be repeated based on the adjusted convex-side distance. Thus, in the course of what may be a plurality of iterations, a path is determined for the vehicle, which on both sides runs approximately equidistant from the edges of the roadway.

If the negotiable road surface is too narrow, it can occur that at least part of the second directrix obtained by the method described above lies outside the negotiable road surface. In other words, the outer front wheel of the vehicle leaves the negotiable road surface. In order to avoid such an event, in the case in which at least part of the second directrix lies outside the negotiable road surface, the convex-side distance can be set to zero, and the method repeated.

In reality, it is not the trailer coupling that follows the movement of the vehicle's front wheels on a tractrix, but the rear axle. In practice, however, this difference is small, and can be neglected for curve diameters that are not too tight. Therefore, in the above-described method, the first tractrix must not necessarily be calculated for the trailer coupling; it can be calculated in relation to any guide point that lies on a line that extends in the vehicle longitudinal direction from the trailer coupling to the rear axle of the vehicle.

In order to detect the edges of the negotiable road surface, images from a camera carried by the vehicle can be evaluated. In order to obtain the first directrix, a straight line can be constructed at each point of the path of travel that intersects the path of travel at a fixed angle given by the dimensions of the trailer. At a fixed distance from the point of intersection each such straight line has a point of the first directrix. Correspondingly, the second directrix can be obtained by constructing, at each point of the first directrix, a straight line intersecting the first directrix at a fixed angle given by the dimensions of the vehicle, and a point on the line at a fixed distance from the point of intersection is accepted as a point of the second directrix.

In a preparatory step, it can be detected as to whether a trailer is present, in order to carry out the above-described method only if the trailer is present, and thus not limit the maneuverability of the vehicle unnecessarily in the absence of the trailer. The presence of the trailer can be checked with an environmental sensor, such as a camera, a radar sensor, or an ultrasound sensor, which is oriented onto the space behind the vehicle. The presence of the trailer can also be detected without such an environmental sensor. Since the mass of a vehicle-and-trailer combination is generally significantly greater than that of the vehicle alone, in the case of a combination the acceleration resulting from a given engine performance is significantly less than that of the vehicle without a trailer. By monitoring the ratio of drive power to the resulting acceleration, therefore, the accelerated mass can be estimated and a decision can be made as to whether or not it includes a trailer.

The subject matter of the present disclosure further includes a driver assistance system for forecasting or planning a trajectory for a vehicle, which is configured to identify a concave and a convex edge of a negotiable road surface; determine a path of travel for a wheel of a trailer of the vehicle facing towards the convex edge, at a convex-side distance from the convex edge; compute a first directrix, on which a guide point of the vehicle must move in order in order to pull the wheel along the path of travel; compute a second directrix, on which a front wheel of the vehicle facing towards the concave edge must move in order to pull the guide point along the first directrix; estimate a concave-side distance between the front wheel and the concave edge; and adjust the convex-side distance so as to be closer to the concave-side distance. The driver assistance system is further configured to determine the path of travel based on the convex-side distance when the difference between the concave-side distance and the convex-side distance exceeds a limiting value.

The driver assistance system may also be configured to set the convex-side distance to zero, and re-determine the path of travel if at least part of the second directrix lies outside the negotiable road surface.

The driver assistance system may include a camera carried by the vehicle so as to identify the edges of the negotiable road surface on the basis of images from this camera. The driver assistance system may also be coupled to an environmental sensor, such as a camera, a radar or ultrasonic sensor, to detect the presence of the trailer.

The subject matter of the present disclosure also includes a computer program product having program code stored on a computer-readable data medium, which when executed on a computer or processor, is configured to execute the above-described method, or to operate as the above-mentioned driver assistance system.

### BRIEF DESCRIPTION OF THE DRAWINGS

The present disclosure will hereinafter be described in conjunction with the following drawing figures, wherein like numerals denote like elements.

FIG. 1 shows a vehicle with a driver assistance system steering the vehicle through a curve; and

FIG. 2 shows a flowchart of a working procedure for the driver assistance system.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

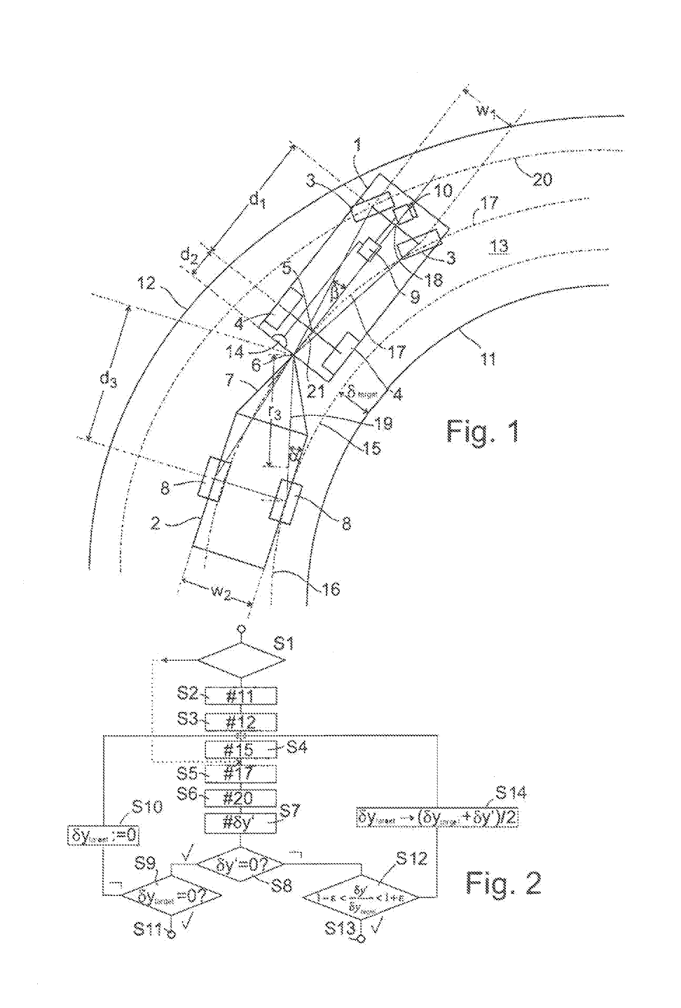

FIG. 1 shows a motor vehicle 1 with a trailer 2 driving through a curve. The vehicle 1 has a front axle with steerable front wheels 3 and a rear axle with rear wheels 4. The front track or distance between the front wheels is designated as w1, and the wheelbase or distance between the axles is designated as d1. The front wheels 3 and a center point 5 of the rear axle form an isosceles triangle of width w1 and height d1.

A trailer coupling 6 is arranged centrally at the rear of the vehicle 1 at a distance d2 from the center point 5 of the rear axle. A drawbar 7 of the trailer 2 is connected such that it can pivot about the trailer coupling 6. The trailer 2 has a single axle with wheels 8. The trailer track or distance between the wheels 8 is designated as w2, and the distance between an axle for the trailer wheels 8 and the trailer coupling 6 is designated as d3. The wheels 8 and the trailer coupling 6 form a second isosceles triangle of width w2 and height d3.

An electronic control unit or microcomputer 9 of the vehicle 1 is connected to a camera 10, which is oriented on the roadway ahead of the vehicle 1 in order to identify the profiles of edges 11, 12 of the negotiable road surface 13 of the roadway on the basis of images supplied by the camera 10.

A sensor 14 at the rear of the vehicle can be a second camera, a radar sensor, or another sensor suitable for monitoring the traffic space behind the vehicle 1. In the context of the present disclosure, the sensor 14 is only required to detect the presence of the trailer 2 such that it is not a problem if the trailer 2 following closely behind the vehicle 1 completely, or almost completely, fills the field of view of the sensor 14. In principle, an electrical resistance connected to a trailer coupling can also indicate the presence of a trailer. However, in this case no distinction can be made between a trailer and, for example, a bicycle rack rigidly mounted on the trailer coupling and without ground contact, so that this criterion is indeed a necessary, but not a sufficient, criterion for the presence of a trailer.

In accordance with an alternative embodiment, the task of the sensor 14 to detect the presence of the trailer 2 is undertaken by an acceleration sensor, or data for the acceleration of the vehicle obtained by derivation from a tachometer signal against time. By dividing the power of an engine of the vehicle 1 by the resulting acceleration, the microcomputer 9 can estimate the inertial mass that is being driven by the engine. If this exceeds a predetermined limiting value, it is assumed that the trailer 2 is coupled.

The working procedure for the microcomputer 9 is illustrated in FIG. 2. At S1, a check is made to determine whether the trailer 2 is coupled to the vehicle 1. If the trailer 2 is coupled, then the profile of the inner or convex edge 11 of the roadway is initially determined on the basis of images from the camera 10 at S2. The profile identification can include calculating plane coordinates of a plurality of points of the edge 11 in a coordinate system related to the vehicle 1 and determining a polynomial that connects the points. The outer or concave edge 12 is correspondingly determined at S3 in a similar manner.

A path of travel 15 for the wheel 8 of the trailer 2 facing towards the convex edge 11, namely the inner trailer wheel, is then determined at S4. This path of travel 15 can be determined on the basis of the previously identified edge profile, such that all points of the path of travel 15 have the same desired distance δytarget=δymin from the polynomial calculated at S2. For reasons that will become apparent from the further description of the procedure, the actual distance δy from the inner wheel 8 to the edge 11 is greater than δymin, so the path of travel 15 is preferably determined such that the distance to the edge 11 in a first section of the path of travel gradually decreases from δy to δymin in order to produce a continuous connection between the impending path of travel 15 and the path of travel 16 already covered by the wheel 8.

The baseline of the triangle formed by the wheels 8 and the trailer coupling 6 is always at right angles to the path of travel 15. At S5, the microcomputer 9 therefore calculates points of a directrix 17 on which the trailer coupling 6 must move in order to guide the inner wheel 8 facing towards the convex edge 11 on the path of travel 15, by constructing a straight line 19, which intersects the path of travel 15 at an angle:

$$α = {tan}^{- 1} \frac{{w}_{2}}{2 {d}_{3}}$$

and by selecting a point on the straight line whose distance r₃ from the crossing point is given by:

$$\sqrt{\frac{{w}_{2}^{2}}{4} + {d}_{3}^{2}}$$

The center point 5 of the rear axle of the vehicle follows the center point 18 of the front axle on a tractrix. The path followed by the trailer coupling 6 deviates from this tractrix because of the non-vanishing distance d2, but this deviation is small as long as the path of the center point 18 does not have excessively tight curves, and here can be neglected, since the curvature of the path is limited by the maximum steering lock of the front wheels 3. This allows the microcomputer 9 to assume that the triangle formed by the trailer coupling 6 and the front wheels 3 is an isosceles triangle of invariable shape with the width w1 and the height d1+d2. In an analogous manner to the calculation of the directrix 17, at S6 the microcomputer 9 therefore calculates a path 20, which the front wheel 3 of the vehicle facing towards the concave edge 12 must follow, in order that the trailer coupling moves along the directrix 17, by constructing at points of the directrix 17 in each case a straight line, which intersects the directrix 17 at the angle:

$$β = {tan}^{- 1} \frac{{w}_{1}}{2 ( {d}_{1} + {d}_{2} )}$$

and by selecting a point on the straight line whose distance r₁ from the crossing point is given by:

$$\sqrt{\frac{{w}_{1}^{2}}{4} + {( {d}_{1} + {d}_{2} )}^{2}}$$

The inaccuracy that results from neglecting the non-vanishing distance d2 between the trailer coupling 6 and the midpoint 5 of the rear axle is comparable if, in step S5, in accordance with an alternative method, a directrix is calculated for the center point 5, by selecting as the angle of the straight lines constructed, originating from the path of travel 15:

$$α = {tan}^{- 1} \frac{{w}_{2}}{2 ( {d}_{2} + {d}_{3} )}$$

and by selecting as the distance r₃ of the point of the directrix:

$$\sqrt{\frac{{w}_{2}^{2}}{4} + {( {d}_{2} + {d}_{3} )}^{2}}$$

and originating from this directrix for the construction of the path 20 an angle:

$$β = {tan}^{- 1} \frac{{w}_{1}}{2 {d}_{1}}$$

and a distance:

$${r}_{1} = \sqrt{\frac{{w}_{1}^{2}}{4} + {d}_{1}^{2}}$$

In general, the directrix 17 can be calculated for any guide point 21 located on the center line of vehicle 1 at a distance ε*d2 from trailer coupling 6 and (1−ε)*d2 from point 5; it then applies that:

$$α = {tan}^{- 1} \frac{{w}_{2}}{2 ( {ed}_{1} + {d}_{3} )} , {r}_{3} = \sqrt{\frac{{w}_{2}^{2}}{4} + {( {ed}_{2} + {d}_{3} )}^{2}}$$

$$and$$

$$β = {tan}^{- 1} \frac{{w}_{1}}{2 ( {d}_{1} + ( 1 - e ) {d}_{2} )} , {r}_{1} = \sqrt{\frac{{w}_{1}^{2}}{4} + {( {d}_{1} + ( 1 - e ) {d}_{2} )}^{2}}$$

At S7, the distance δy′ to the concave edge 12 is estimated for the path 20 thus obtained. If it appears at S8 that this distance is locally zero, i.e. if the path 20 touches or crosses over the edge 12, then the forecasted path is unsuitable for driving, and the microcomputer 9 sets the distance δytarget to zero at S10 and returns to S4. However, if the path 20 touches or crosses over the edge 12 beforehand at S9 such that δytarget has already been previously set to zero, then the curve is not negotiable, and the microcomputer 9 issues a braking command for the vehicle 1 itself, or a warning signal for the driver to do so at S11.

If the distance δy′ is greater than zero over the entire path 20, then at S12 the minimum of δy′ is compared with the distance δytarget between the path of travel 15 and the edge 11. If both distances are approximately equal, i.e. if:

$$1 - ɛ < \frac{δ {y}^{′}}{δ {y}_{soll}} < 1 + ɛ$$

When soll=target is fulfilled, then the path 20 is suitable and can be negotiated. The microcomputer 9 can issue a steering command fully autonomously at S13. Alternatively, the microcomputer 9 may signal or display the path 20 to a driver. For example, an actuator controlled by the microcomputer 9 may exert a torque on a steering wheel of the vehicle in the direction of the position required for driving along the path 20, such that the driver may decide whether to follow the signaled path, or to overcome the torque of the actuator to drive along another path.

If the distances δy′ and δytarget differ too greatly at S12, then at S14 δytarget is adjusted so as to be closer to δy′, for example by a fixed increment or decrement, or by forming an average value. The process may then be repeated from S4 with the new value of δytarget thus obtained. This ensures that, if the roadway offers sufficient space, a path of travel is selected for the vehicle 1 and trailer 2 that is approximately equidistant from both edges 11, 12.

If the presence of a trailer is not detected at S1, a simplified modification of the method described above may be implemented, in which, based on the profile of the edge 11 in accordance with the above-described principles, a path of travel is determined, not for a trailer wheel, but instead for the rear wheel 4 of the vehicle 1 facing towards the edge 11. The resulting path 17 of the guide point 21 is forecasted, and, as indicated in FIG. 2 by a dashed line, the process proceeds from S5 and following on the basis of this path 17.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment as contemplated herein. It should be understood that various changes may be made in the function and arrangement of elements described in an exemplary embodiment without departing from the scope of the invention as set forth in the appended claims.

1-12. (canceled)

13. A method for operating a vehicle pulling a trailer through a cornering maneuver comprising:
identifying a concave edge and a convex edge of a negotiable road surface;
determining a path of travel for an inner wheel of the facing towards the convex edge having a convex-side distance from the convex edge;
computing a first directrix, on which a guide point of the vehicle must move in order to pull the inner wheel along the path of travel;
computing a second directrix, on which an outer, front wheel of the vehicle facing towards the concave edge must move in order to pull the guide point along the first directrix;
estimating a concave-side distance between the outer, front wheel and the concave edge;
computing an adjusted path of travel such that the convex-side distance is closer to the concave-side distance when a difference between the concave-side distance and convex-side distances exceeds a threshold value; and
issuing a command indicating the adjusted path of travel.

14. The method in accordance with claim 13, wherein issuing a command comprises generating a steering input for the vehicle.

15. The method in accordance with claim 13, wherein issuing a command comprises signaling an steering input for the vehicle.

16. The method in accordance with claim 13, further comprising setting the convex-side distance to zero when at least part of the second directrix lies outside the negotiable road surface.

17. The method in accordance with claim 13, further comprising selecting the guide point on a line that extends in the vehicle longitudinal direction from a trailer coupling to a rear axle of the vehicle.

18. The method in accordance with claim 13, further comprising acquiring an image of the negotiable road surface with an on-board camera for determining the convex and concave edges.

19. The method in accordance with claim 13, further comprising computing the first directrix such that, at each point on the path of travel there exists a first point on the first directrix that is connected to the point on the path of travel by a straight line of constant length, which intersects the path of travel at a first angle that remains constant.

20. The method in accordance with claim 19, further comprising computing the second directrix such that at each point on the first directrix there exists a second point on the second directrix that is connected to the point on the first directrix by a straight line of constant length, which intersects the first directrix at a second angle that remains constant.

21. The method in accordance with claim 13, further comprising detecting the presence of the trailer coupled to the vehicle.

22. The method in accordance with claim 13, further comprising detecting the presence of the trailer coupled to the vehicle an environmental sensor.

23. The method in accordance with claim 13, wherein detecting the presence of the trailer coupled to the vehicle comprises determining that the vehicle is pulling a trailer based on a by comparison of an engine load and an associated vehicle acceleration.

24. A non-transitory computer readable medium comprising processor-executable instructions for reading data from a processor in communication with a camera onboard a vehicle pulling a trailer through a cornering maneuver, the processor-executable instructions when executed on the processor in a device configure the device to:
identify a concave edge and a convex edge of a negotiable road surface from image acquired by the camera;
determine a path of travel for an inner wheel of the facing towards the convex edge having a convex-side distance from the convex edge;
compute a first directrix, on which a guide point of the vehicle must move in order to pull the inner wheel along the path of travel;
compute a second directrix, on which an outer, front wheel of the vehicle facing towards the concave edge must move in order to pull the guide point along the first directrix;
estimate a concave-side distance between the outer, front wheel and the concave edge;
compute an adjusted path of travel such that the convex-side distance is closer to the concave-side distance when a difference between the concave-side distance and convex-side distances exceeds a threshold value; and
issue a command indicating the adjusted path of travel.

25. A driver assistance system for operating a vehicle pulling a trailer through a cornering maneuver comprising an electronic control unit configured to:
identify a concave edge and a convex edge of a negotiable road surface;
determine a path of travel for an inner wheel of the facing towards the convex edge having a convex-side distance from the convex edge;
compute a first directrix, on which a guide point of the vehicle must move in order to pull the inner wheel along the path of travel;
compute a second directrix, on which an outer, front wheel of the vehicle facing towards the concave edge must move in order to pull the guide point along the first directrix;
estimate a concave-side distance between the outer, front wheel and the concave edge;
compute an adjusted path of travel such that the convex-side distance is closer to the concave-side distance when a difference between the concave-side distance and convex-side distances exceeds a threshold value; and
issue a command indicating the adjusted path of travel.

26. The driver assistance system in accordance with claim 25, wherein the electronic control unit is further configured to generating a steering input for the vehicle.

27. The driver assistance system in accordance with claim 25, wherein the electronic control unit is further configured to signal an steering input for the vehicle.
